(19) United States
(12) Patent Application Publication
(10) Pub. No.: US 2006/0163240 A1
(43) Pub. Date: Jul. 27, 2006

(54) Mini scented wax heating device

(76) Inventor: Ming Ren Xiao, Dongguan (CN)

Correspondence Address: CHARLES E. BAXLEY, ESQ., 90 JOHN STREET, THIRD FLOOR, NEW YORK, NY, 10038, US

(21) Appl. No.: 11/042,727

(22) Filed: Jan. 24, 2005

(51) Int. Cl. F27D 11/00

(52) U.S. Cl. 219/438

(57) ABSTRACT

A mini scented wax heating device includes a heating cylinder which is in a penetrating cylindrical form and installs a heating device therein. The heating device comprises a heat plate and a ceramic heating piece attached to the heat plate, and the heat plate is latched to a fixed end of the heating cylinder. The invention uses the heat plate to directly heat the bottom of the heating device. Since the heating device is a mini heating device that heats the heat plate directly by the ceramic heating piece, the heat plate can directly heat and vaporize a piece of scented wax. The invention increases the heating area of the scented wax by the heater, shortens the heating time, and evenly heats the scented wax in the heater, and thus can achieve a better vaporization effect. The invention features a simple structure, a low cost, and a powerful function.

### BACKGROUND OF THE INVENTION

1. Field of the Invention

The present invention generally relates to a mini scented wax heating device, and more particularly to a mini electric scented wax heating device that heats an essential oil or scented wax to produce an aromatic gas.

2. Description of the Related Art

In general, an air refresher, a solid scent or an essential oil is used to eliminating any peculiar smell in the air at home, in office, or in public places. These scented items are usually vaporized at room temperature to achieve the air refreshing effect. However, the effect of such evaporating method is generally affected by the change of temperature, humidity and air flow of the environment, and thus the extent of the vaporization of these scented items is affected accordingly.

At present, some people are using a common electric scented wax heating device sold in the market. With reference to FIG. 1, the heating device comprises a heater 1, and the heating device includes two handles 2 on the external surface of the heater 1, and the handles 2 are provided for facilitating users to move the heating device freely.

A symmetric fixed arm 3 is transversally installed at the bottom of the heater 1, and a heating piece 4 is securely fixed by a screw 5, and the screw 5 passes through a positioning hole on a positioning plate 6, such that both ends of the positioning plate 6 press on the fixed arm 3 at the bottom of the heater 1. An electric wire 7 with a plug is connected to the heating piece 4. Different kinds of scented waxes are placed into the foregoing heater 1 directly for heating and vaporizing the scented wax. However, such structural design still has the following shortcomings in the heating process. For instance, a single heating piece 4 is used to heat the bottom of the heater 1, such that the heated bottom of the heater 1 vaporizes the scented wax contained in the heater 1. Since the area occupied by the heating piece 4 is quite small, therefore the area of the heated bottom of the heater 1 is also small. Furthermore, the bottom of the heater 1 is made of a ceramic material which is not a good thermal conductor. Therefore, the heating process for the scented wax not only takes a long preheating time, but also has difficulties to timely disperse the heating temperature from the small heated area at the bottom of the heater 1. As a result, the heat cannot be conducted evenly that gives rise to a poor vaporization of the scented wax.

### SUMMARY OF THE INVENTION

The primary objective of the present invention is to overcome the shortcomings of the prior arts by providing a mini scented wax heating device for heating a scented wax, which improves the traditional heating method, increases the heating area of the heating device, shortens the heating time, and evenly heats the heating device so as to provide a better vaporization effect.

To achieve the foregoing objective, the present invention adopts the technical solutions as described below:

A mini scented wax heating device comprises a heating cylinder, and the heating cylinder is in a penetrating cylindrical form and installs a heating device therein. The heating device comprises a heat plate and a ceramic heating piece attached to the heat plate, and the heat plate is latched to a fixed end of the heating cylinder. The heat plate is circular, square, or in any other geometric shape, and the fixed end could be a continuous or a non-continuous flange or groove disposed on an internal wall of the heating cylinder. The heat plate includes a U-shape fixing bracket, and the fixing bracket includes a screw fixing hole. The fixing bracket builds a ceramic heating piece therein, and the ceramic heating piece is connected to an electric wire for an electric connection to a power supply. A bolt passes through the fixing hole on the fixing bracket to press the ceramic heating piece. The bolt is connected to a chassis, and the chassis has a through hole, which is designed for passing a bolt to achieve the fixing effect. The heating cylinder is made of a ceramic material.

The key point of the design of the present invention resides on that the heat plate in the heating device heats up the bottom of the heater. Since the heater is a mini heating device that heats the heat plate directly by the ceramic heating piece, the heat plate can directly heat and vaporize a piece of scented wax. The present invention has the advantages of increasing the heating area of the scented wax by the heater, shortening the heating time, and evenly heating the scented wax in the heater so as to achieve a better vaporization effect. The invention features a simple structure, a low cost, and a powerful function.

The above and other objects, features and advantages of the present invention will become apparent from the following detailed description taken with the accompanying drawings.

### BRIEF DESCRIPTION OF THE DRAWINGS

FIG. 1 is a schematic view of a mini scented wax heater according to a prior art;

FIG. 2 is an exploded view of a mini scented wax heater according to the present invention;

FIG. 3 is a schematic view of a partial structure of a mini scented wax heater according to the present invention; and

FIG. 4 is a schematic view of a whole structure of a mini scented wax heater according to the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

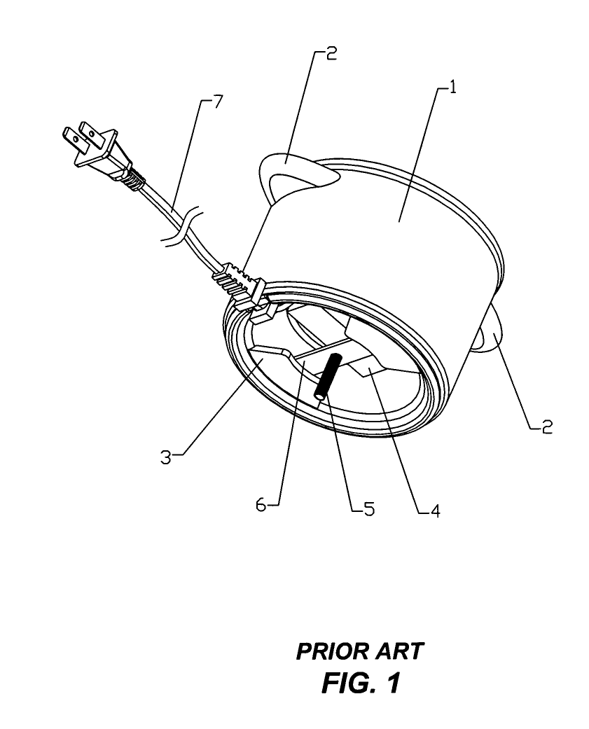

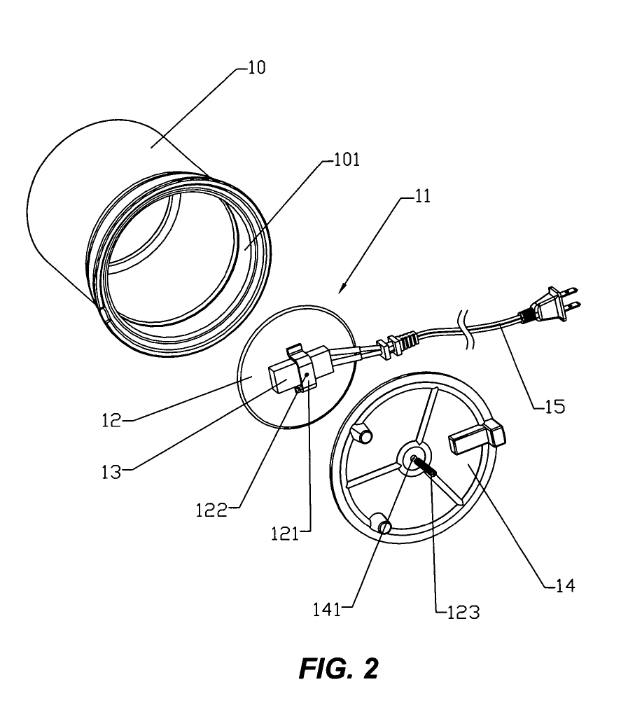

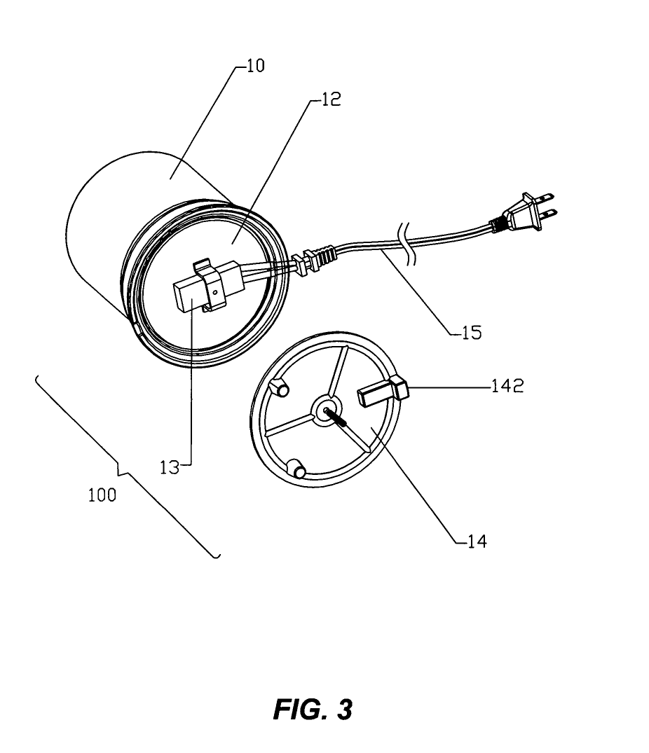

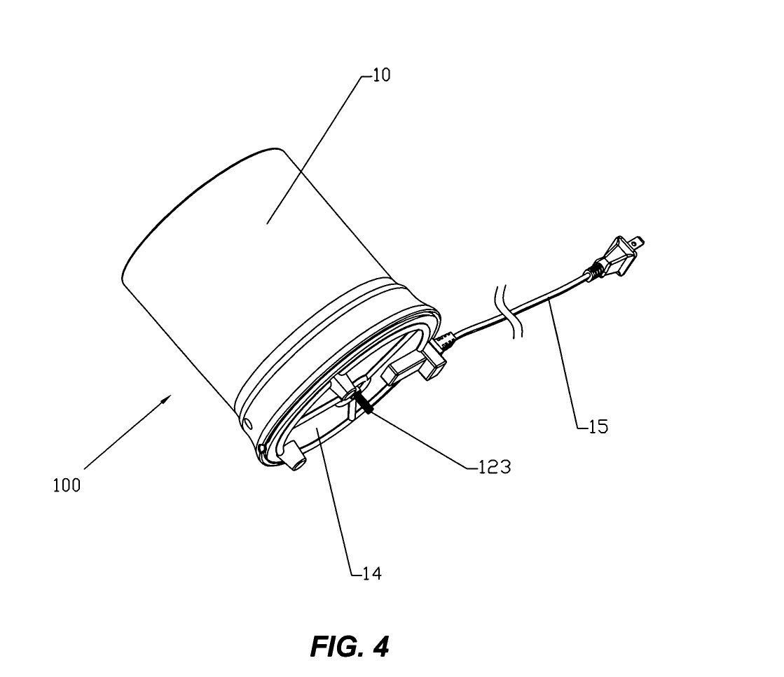

Please refer to FIGS. 1 to 4 for a preferred embodiment of the present invention. A mini scented wax heating device 100 comprises a heating cylinder 10, and the heating cylinder 10 is in a penetrating cylindrical form, and the heating cylinder 10 comprises a heater 11, and the heater 11 is comprised of a heat plate 12 and a ceramic heating piece 13 installed onto the heat plate 12, and the heat plate 12 is latched to a fixed end 101 in the heating cylinder 10. The heat plate 12 could be circular, square, or any other geometric shape. The fixed end 101 could be a continuous or a non-continuous flange or groove disposed on an internal wall of the heating cylinder 10. The heat plate 12 has a U-shape fixing bracket 121, and the fixing bracket has a fixing hole 122 for securing a bolt 123. The fixing bracket 121 builds a ceramic heating piece 13 in the heating device 11, and the ceramic heating piece 13 is connected to an electric wire 15 for an electric connection to a power supply. A bolt 123 passes through the fixing hole 122 of the fixing bracket 121 to press the ceramic heating piece 13, such that the ceramic heating piece 13 is fixed into the heat plate 12. The bolt 123 is connected to a chassis 14, and the chassis has a through hole 141 and a wire groove 142. The through hole 141 is designed for passing a bolt 123 to connect the chassis and achieving the fixing effect. The wire groove 142 is provided for the electric wire 15 to be extended out of the heater. The heating cylinder 10 is made of a ceramic material.

The key point of the design of the present invention resides on that the heat plate 12 in the heating device heats up the bottom of the heater 100. Since the heater 100 is a mini heating device that heats the heat plate 12 directly by the ceramic heating piece 13, the heat plate 12 can directly heat and vaporize a piece of scented wax. The present invention has the advantages of using the heat plate 13 to increase the heating area of the scented wax by the heater, shortening the heating time, and evenly heating the scented wax in the heater so as to achieve a better vaporization effect.

Only a preferred embodiment of the present invention regarding a mini scented wax heating device has been described in the specification and illustrated in the drawings, but it should be pointed out that many other modifications are conceivable within the scope of the following claims.

What is claimed is:

1. A mini scented wax heating device, comprising a heating cylinder, characterized in that said heating cylinder is on a penetrating cylindrical form and comprises a heater, and the heater is comprised of a heat plate and a ceramic heating piece installed onto said heat plate, and said heat plate is latched onto a fixed end in said heating cylinder.

2. The mini scented wax heating device of claim 1, wherein said heat plate is circular or in any other geometric shape.

3. The mini scented wax heating device of claim 1, wherein said fixed end further comprises a continuous or a non-continuous flange or groove disposed on an internal wall of said heating cylinder.

4. The mini scented wax heating device of claim 1, wherein said heat plate comprises a U-shape fixing bracket, and said fixing bracket includes a screw fixing hole.

5. The mini scented wax heating device of claim 2, wherein said heat plate comprises a U-shape fixing bracket, and said fixing bracket includes a screw fixing hole.

6. The mini scented wax heating device of claim 4, wherein said fixing bracket builds in a ceramic heating piece, and a bolt passes through said fixing hole of said fixing bracket to press on said ceramic heating piece.

7. The mini scented wax heating device of claim 5, wherein said fixing bracket builds in a ceramic heating piece, and a bolt passes through said fixing hole of said fixing bracket to press on said ceramic heating piece.

8. The mini scented wax heating device of claim 6, wherein said bolt couples a chassis, and said chassis includes a through hole.

9. The mini scented wax heating device of claim 7, wherein said bolt couples a chassis, and said chassis includes a through hole.

10. The mini scented wax heating device of claim 1, wherein said heating cylinder is made of a ceramic material.
